(19) United States
(12) Patent Application Publication
(10) Pub. No.: US 2019/0005261 A1
(43) Pub. Date: Jan. 3, 2019

(54) SECURE SHARED VAULT WITH ENCRYPTED PRIVATE INDICES

(71) Applicant: International Business Machines Corporation, Armonk, NY (US)

(72) Inventors: Ilya Volvovski, Chicago, IL (US); S. Christopher Gladwin, Chicago, IL (US); Gary W. Grube, Barrington Hills, IL (US); Timothy W. Markison, Mesa, AZ (US); Jason K. Resch, Chicago, IL (US); Thomas F. Shirley, JR., Wauwatosa, WI (US); Greg R. Dhuse, Chicago, IL (US); Manish Motwani, Chicago, IL (US); Andrew D. Baptist, Mt. Pleasant, WI (US); Wesley B. Leggette, Chicago, IL (US)

(21) Appl. No.: 16/125,043

(22) Filed: Sep. 7, 2018

Related U.S. Application Data
(63) Continuation-in-part of application No. 14/172,140, filed on Feb. 4, 2014, now Pat. No. 10,075,523.
(60) Provisional application No. 61/807,288, filed on Apr. 1, 2013.

(51) Int. Cl. G06F 21/62; H04L 29/08; G06F 17/30

(52) U.S. Cl. CPC G06F 21/6218; G06F 17/30002; G06F 17/30961; H04L 67/1097

(57) ABSTRACT

A store-data-object request, which includes a data object and a data identifier, is received from a requesting device. The data object is stored in a shared vault at a shared-vault-data-object address, and an entry in a private index is updated using a private credential associated with the requesting device. The private index includes private information identifying a storage location of the data object in a non-private shared vault. The entry in the private index includes the data identifier.

### CROSS-REFERENCE TO RELATED APPLICATIONS

This application claims priority pursuant to 35 U.S.C. § 120 as a continuation-in-part of U.S. Utility application Ser. No. 14/172,140, entitled “EFFICIENT STORAGE OF DATA IN A DISPERSED STORAGE NETWORK”, filed Feb. 4, 2014, scheduled to issue as U.S. Pat. No. 10,075,523 on Sep. 11, 2018, which claims priority pursuant to 35 U.S.C. § 119(e) to U.S. Provisional Application No. 61/807,288, entitled “DE-DUPLICATING DATA STORED IN A DISPERSED STORAGE NETWORK”, filed Apr. 1, 2013, all of which are hereby incorporated herein by reference in their entirety and made part of the present U.S. Utility Patent Application for all purposes.

### BACKGROUND

This invention relates generally to computer networks and more particularly to dispersing error encoded data.

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

When storing data for multiple users, conventional systems usually store the data for each user in separately from the data of other users, and control access to the user's data by requiring specific authentication to allow only certain users to access data stored in a particular memories or memory portions.

### SUMMARY

According to an embodiment of the present invention, a method includes receiving a store-data-object request from a requesting device, the store-data-object request including a data object and a data identifier. The method can store the data object in a shared vault at a shared-vault-data-object address, and update an entry in a private index using a private credential associated with the requesting device. The private index including private information identifying a storage location of the data object in a non-private shared vault, and the entry in the private index includes the data identifier.

Updating the entry in a private index can include accessing the private index using the private credential, retrieving encoded data slices from the shared vault, decoding the encoded data slices to recover an index node, updating an index node to generate an updated index node, encoding the updated index node to produce updated slices; and storing information associated with the updated slices in the private index.

In some embodiments, a method includes deriving a source name of a root index node by applying a deterministic function to the private credential, and choosing names of intermediate index nodes and leaf nodes to include a random component. The names of intermediate index nodes and leaf nodes can be derived from the private credential.

A method can also include receiving a retrieve data request including the data identifier, extracting a shared-vault-data-object address associated with the data identifier from the private index using the private credential, and recovering the data object from the shared vault using the shared-vault-data-object address.

Various embodiments can be implemented as a distributed storage (DS) processing module including a processor; memory coupled to the processor; and at least one network interface coupled to a requesting device and a distributed storage network (DSN) memory. In some cases, the invention can be implemented as a DSN including a DSN memory and a DS processing module. The DSN includes a processor and associated memory, and is configured to maintain a shared vault and an index vault, where the shared vault provides shared storage for multiple different requesting devices, and the index vault stores private indexes associated with the multiple different requesting devices. Each private index includes private information identifying a storage location of data objects stored in the shared vault. The DS processing module also includes a processor and associated memory, and is configured to receive a store-data-object request from a requesting device, the store-data-object request including a data object and a data identifier, store the data object in a shared vault included in the DSN memory, and update an entry in a private index

### BRIEF DESCRIPTION OF THE DRAWINGS

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of another embodiment of a dispersed storage system in accordance with the present invention; and

FIG. 10 is a flowchart illustrating another example of accessing data in accordance with the present invention.

### DETAILED DESCRIPTION

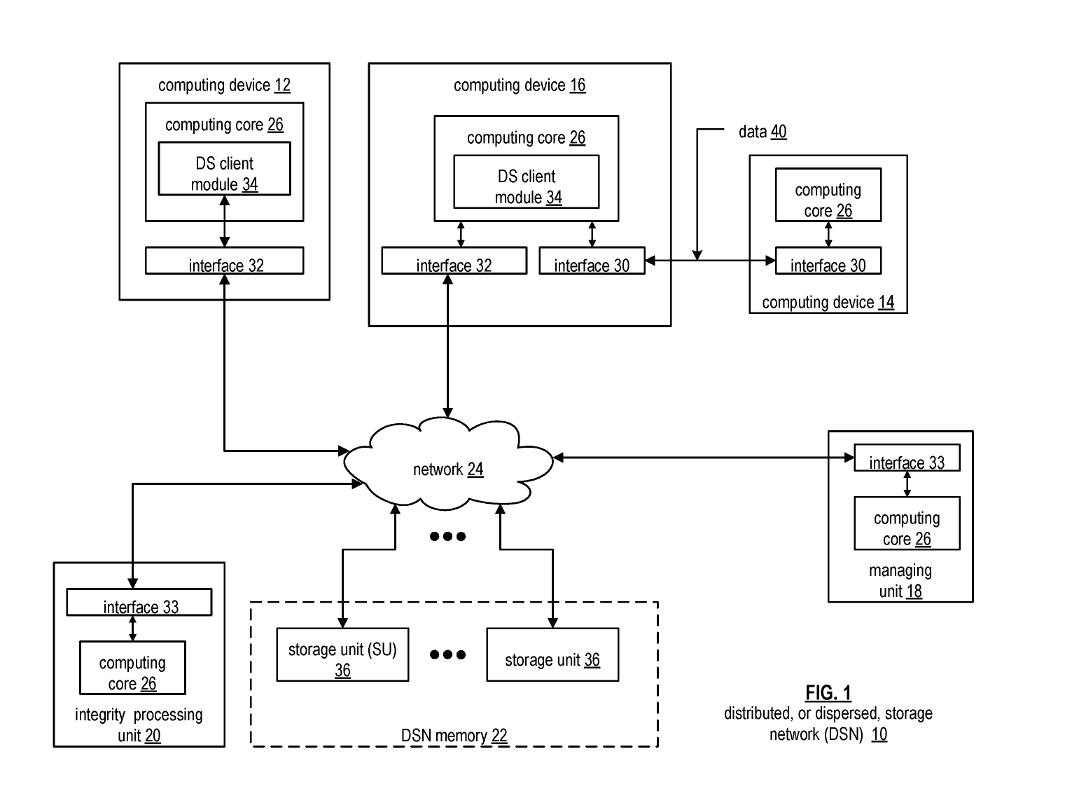

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

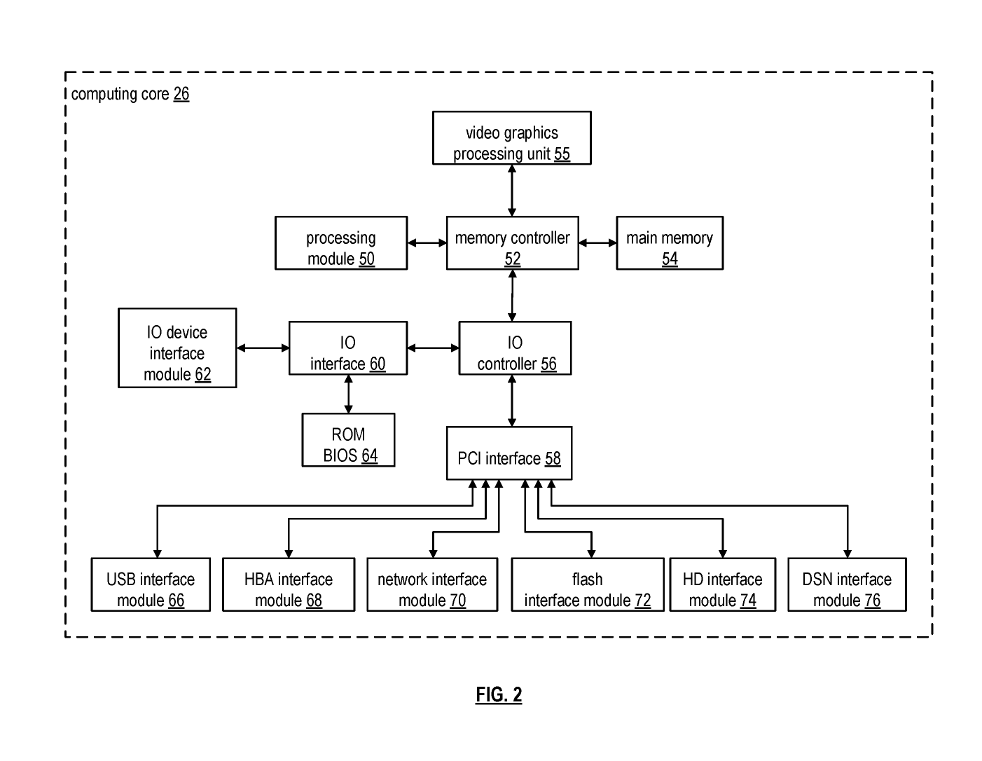

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

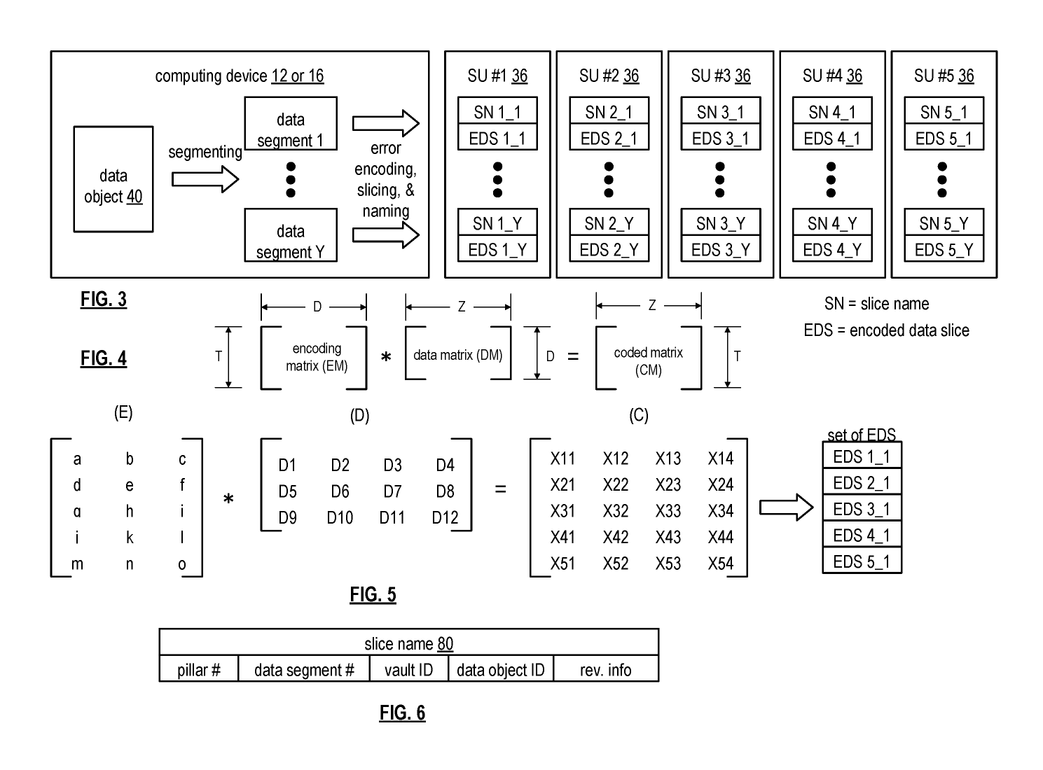

Computing devices 12 and 16 include a dispersed storage (DS) client module 34, which enables the computing device to dispersed storage error encode and decode data (e.g., data 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate a per-access billing information. In another instance, the managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (TO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

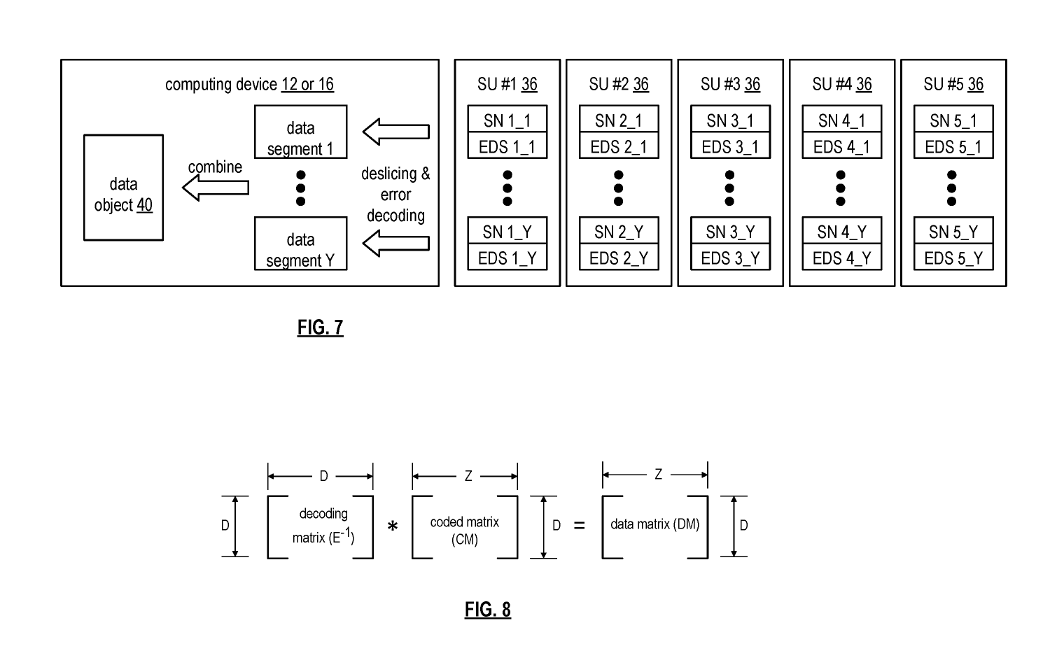

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

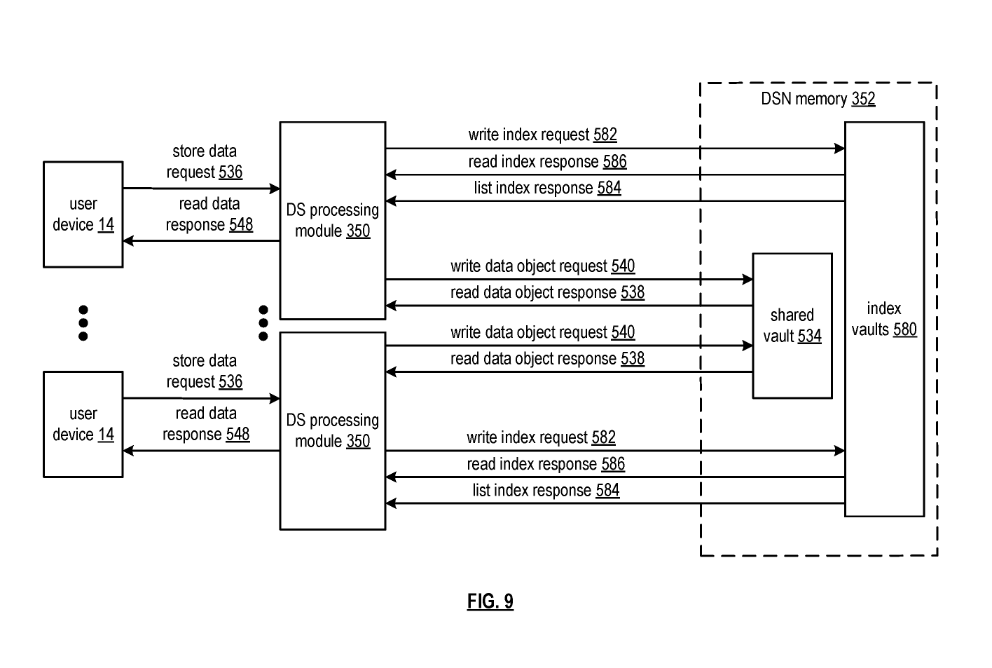

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

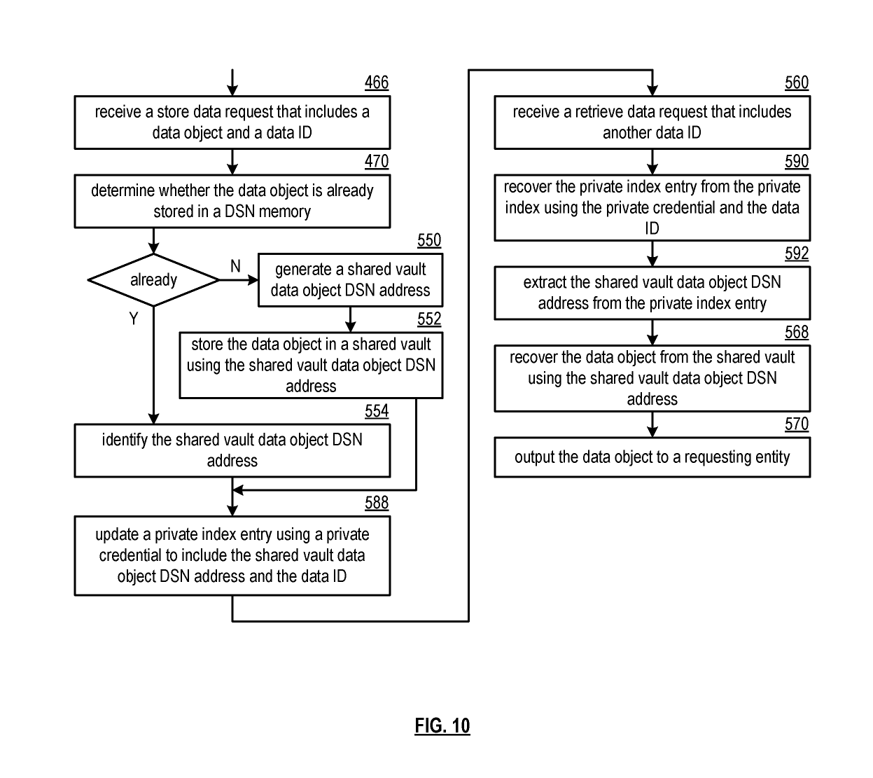

Referring next to FIGS. 9-10, various embodiments of a secure shared vault with encrypted private indices will be discussed. In at least some embodiments, to create a public or shared vault that does not require private vaults for each entity, the following approach is employed.

Each entity accesses the shared vault has their own private credential, in the form of an encryption key. Each entity also creates their own dispersed index. The root node of this index is determined based on the user's private credential. For example, the source name of the root node is derived from some deterministic function (hash, hash-based message authentication code (HMAC), mask generation function (MGF) applied to that entity's private key. The inability to correctly guess the name of the root node preserves confidentiality for the list of files/objects owned by that entity. However, the entity, possessing its private credentials, can determine the name of the root node and by extension, get to all other nodes in the tree structure.

Names of intermediate nodes, leaf nodes, and objects, can be chosen with a random component, or with a component derived from the private credentials, to preserve the unpredictability of the node/object names. Thus no specific authentication is required for accessing this vault, and nearly a vast number of users could be supported without risk of any user accessing data of another user.

One advantage, among many of this approach, is that the system need not know the identity of the user, providing inherent anonymity. For additional security, the index nodes and the content itself may be encrypted with an encryption key derived from the user's private credentials and the name of the object/node being stored. In at least some embodiments, unencrypted listing must not be supported for the secrecy of the names to remain intact.

FIG. 9 is a schematic block diagram of another embodiment of a dispersed storage system that includes the plurality of user devices 14, which can be instances of computing device 12 of FIG. 1, the plurality of dispersed storage (DS) processing modules 350, which can instances of computing device 16 of FIG. 1, and the dispersed storage network (DSN) memory 352, which is an example of DSN memory 22 of FIG. 1. The DSN memory 352 includes storage facilities for at least one the shared vault 534 and index vaults 580. The storage facilities include a plurality of DS units. The DS units may be organized into one or more sets of DS units. Each DS unit of the one or more sets of DS units may be implemented utilizing one or more of storage units 36 of FIG. 1, a storage node, a distributed storage and task (DST) execution unit, such as DSN memory 22, a storage server, a storage unit, a storage module, a memory device, a memory, a user device, such as computing device 12 of FIG. 1, a DST processing unit, such as computing device 12 of FIG. 1, and a DST processing module such as DS processing module 350.

The system functions to access a data object in the shared vault 534 of the DSN memory 352 in accordance with a data de-duplication approach. The data de-duplication approach includes access controls with regards to the at least one shared vault 534 and the index vaults 580. For example, each user device 14 of the plurality of user devices may access the shared vault 534 to access de-duplicated data. As another example, user device 14 of the plurality of user devices may access the index vaults 580 to access link-objects associated with data objects stored in the shared vault 534.

In an example of operation of the data de-duplication approach, when the accessing of the data object includes storing the data object, a user device 14 issues a store data request 536 to a DS processing module 350 to store the data object in the DSN memory 352, where the store data request 536 includes one or more of a received data object, a data identifier (ID) of a plurality of data IDs associated with the data object, and a data tag (e.g., a result of performing a deterministic function on at least a portion of the data object). The DS processing module 350 determines whether the received data object matches a data object stored in the shared vault 534. The determining includes at least one of comparing the received data object to data objects stored in the shared vault, obtaining a data tag associated with the received data object, generating the data tag associated with the received data object, and comparing the data tag associated with the received data object with a data tag list.

When the data object is not stored in the shared vault 534, the DS processing module 350 stores the data object in the shared vault 534 at a data object DSN address by issuing a write data object request 540 to the shared vault. The issuing includes encoding the received data object to produce slices and issuing write slice requests to the shared vault 534 that includes the slices. The DS processing module 350 utilizes a private credential of the user device 14 to update an entry of a private hierarchical dispersed index of the index vaults 580 associated with the user device 14 to include the data object DSN address and the data ID as an updated entry. The updating may include issuing a list index request to the private hierarchical dispersed index, receiving a list index response 584, and identifying the entry from the list index response. The updating further includes issuing a read index request to the private hierarchical dispersed index and receiving a read index response 586 that includes the entry. The updating still further includes issuing a write index request 582 to the private hierarchical dispersed index to include the updated entry. When the data object is stored in the shared vault 534, the DS processing module 350 utilizes the private credential of the user device to update the entry of the private hierarchical dispersed index of the index vaults associated with the user device to include the data object DSN address and the data ID as the updated entry.

In another example of the data de-duplication approach, when the accessing of the data object includes retrieving the data object, another user device 14 (e.g., any user device of the plurality of user devices) issues a read data request to another DS processing module 350 (e.g., may include the DS processing module associated with storage of the data object) to retrieve the data object stored in the shared vault 534 of the DSN memory 352, where the read data request includes another data ID associated with the data object (e.g., the other data ID may include the data ID). The other DS processing module 350 utilizes a private credential of the other user device 14 to access another private hierarchical dispersed index associated with the other user device using the other data ID to recover the data object DSN address. The recovering may include issuing a list index request to the other private hierarchical dispersed index, receiving a list index response 584, and identifying an entry from the list index response 584. The updating further includes issuing a read index request to the other private hierarchical dispersed index and receiving a read index response 586 that includes the entry that includes the data object DSN address.

The other DS processing module recovers the data object from the shared vault 534 using the data object DSN address extracted from the link-object. The recovering includes issuing a read data object request (e.g., issuing one or more sets of read slice requests) to the shared vault 534 using the data object DSN address and receiving a read data object response 538 (e.g., decoding received slices) that includes the data object. The other DS processing module 350 issues a read data response 548 to the user device 14 that includes the data object.

FIG. 10 is a flowchart illustrating another example of accessing data. The method begins with steps 466 and 470, where a processing module (e.g., of a dispersed storage (DS) processing module) receives a store data request that includes a data object and a data identifier (ID) and determines whether the data object is already stored in a dispersed storage network (DSN) memory. The method branches to step 554 when the data object is already stored in the DSN memory. The method continues to step 550 when the data object is not already stored in the DSN memory. The method continues with steps 550 and 552, where the processing module generates a shared vault data object DSN address and stores the data object in a shared vault using the shared vault data object DSN address. The method branches to step 588.

The method continues with step 554, where the processing module identifies the shared vault data object DSN address when the data object is already stored in the DSN memory. The method continues at step 588 where the processing module updates a private index entry using a private credential to include one or more of the shared vault data object DSN address, the data ID, and a data tag associated with the data object. The updating includes one or more of accessing the private index using the private credential and updating an index node of the private index (e.g., retrieving slices, decoding slices to recover the index node, updating/modifying the index node, and encoding the updated/modified index node to produce updated slices, and storing the updated slices in the private index). The updating may also include recovering metadata associated with storage of the data object in the shared vault, updating the metadata to increment a copy count by one, and storing the updated metadata in the DSN memory (e.g., in the shared vault).

When receiving a retrieve data request, the method continues with step 560, where the processing module receives a retrieve data request that includes another data ID. The method continues at step 590 where the processing module recovers the private index entry from the private index using the private credential and the data ID. The recovering includes accessing the private index using the private credential, identifying the index node of the private index, retrieving slices of the index node, decoding the slices to reproduce the index node, and extracting the private index entry. The method continues at step 592 where the processing module extracts the shared vault data object DSN address from the private index entry. The method continues with steps 568 and 570, where the processing module recovers the data object from the shared vault using the shared vault data object DSN address and outputs the data object to a requesting entity associated with the retrieve data request.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprising:
receiving a store-data-object request from a requesting device, the store-data-object request including a data object and a data identifier;
storing the data object in a shared vault at a shared-vault-data-object address; and
updating an entry in a private index using a private credential associated with the requesting device, the private index includes private information identifying a storage location of the data object in a non-private shared vault, and the entry in the private index includes the data identifier.

2. The method of claim 1, wherein updating the entry in a private index includes:
accessing the private index using the private credential.

3. The method of claim 1, wherein updating the entry in a private index includes:
retrieving encoded data slices from the shared vault;
decoding the encoded data slices to recover an index node;
updating an index node to generate an updated index node;
encoding the updated index node to produce updated slices; and
storing information associated with the updated slices in the private index.

4. The method of claim 1, further comprising:
deriving a source name of a root index node by applying a deterministic function to the private credential.

5. The method of claim 1, further comprising:
choosing names of intermediate index nodes and leaf nodes to include a random component.

6. The method of claim 1, further comprising:
deriving names of intermediate index nodes and leaf nodes from the private credential.

7. The method of claim 1, further comprising:
receiving a retrieve data request including the data identifier;
extracting a shared-vault-data-object address associated with the data identifier from the private index using the private credential; and
recovering the data object from the shared vault using the shared-vault-data-object address.

8. A distributed storage (DS) processing module comprising:
a processor;
memory coupled to the processor;
at least one network interface coupled to a requesting device and a distributed storage network (DSN) memory;
the processor configured to:
receive, via the at least one network interface, a store-data-object request from a requesting device, the store-data-object request including a data object and a data identifier;
store the data object in a shared vault at a shared-vault-data-object address, the shared vault included in the DSN memory; and
update an entry in a private index using a private credential associated with the requesting device, the entry in the private index includes the data identifier, wherein the private index is maintained in a DSN memory and includes private information identifying a storage location of the data object in a non-private shared vault.

9. The distributed storage (DS) processing module of claim 8, wherein the processor is further configured to:
update the entry in a private index by accessing the private index using the private credential.

10. The distributed storage (DS) processing module of claim 8, wherein:
the processor is configured to update the entry in a private index by:
retrieving encoded data slices from the shared vault;
decoding the encoded data slices to recover an index node;
updating an index node to generate an updated index node;
encoding the updated index node to produce updated slices; and
storing information associated with the updated slices in the private index.

11. The distributed storage (DS) processing module of claim 8, wherein the processor is further configured to:
derive a source name of a root index node by applying a deterministic function to the private credential.

12. The distributed storage (DS) processing module of claim 8, wherein the processor is further configured to:
choose names of intermediate index nodes and leaf nodes to include a random component.

13. The distributed storage (DS) processing module of claim 8, wherein the processor is further configured to:
derive names of intermediate index nodes and leaf nodes from the private credential.

14. The distributed storage (DS) processing module of claim 8, wherein the processor is further configured to:
receive a read data request including the data identifier from the requesting device;
extract a shared-vault-data-object address associated with the data identifier from the private index using the private credential; and
recover the data object from the shared vault using the shared-vault-data-object address.

15. A distributed storage network (DSN) comprising:
a DSN memory including a processor and associated memory, the DSN memory configured to maintain a shared vault and an index vault;
the shared vault configured to provide shared storage for a plurality of different requesting devices;
the index vault configured to store a plurality of private indexes associated with the plurality of requesting device, wherein each private index includes private information identifying a storage location of data objects stored in the shared vault;
a distributed storage (DS) processing module coupled to the DSN memory, and including a second processor and associated memory, the DS processing module configured to:
receive a store-data-object request from a requesting device, the store-data-object request including a data object and a data identifier;
store the data object in a shared vault at a shared-vault-data-object address, the shared vault included in the DSN memory; and
update an entry in a private index using a private credential associated with the requesting device, the entry in the private index includes the data identifier.

16. The distributed storage network (DSN) of claim 15, wherein the DS processing module is further configured to:
update the entry in a private index by accessing the private index using the private credential.

17. The distributed storage network (DSN) of claim 15, wherein the DS processing module is further configured to:
retrieve encoded data slices from the shared vault;
decode the encoded data slices to recover an index node;
update an index node to generate an updated index node;
encode the updated index node to produce updated slices; and
store information associated with the updated slices in the private index.

18. The distributed storage network (DSN) of claim 15, wherein the DS processing module is further configured to:
derive a source name of a root index node by applying a deterministic function to the private credential; and
choose names of intermediate index nodes and leaf nodes to include a random component.

19. The distributed storage network (DSN) of claim 15, wherein the DS processing module is further configured to:
derive names of intermediate index nodes and leaf nodes from the private credential.

20. The distributed storage network (DSN) of claim 15, wherein the DS processing module is further configured to:
receive a read data request including the data identifier from the requesting device;
extract a shared-vault-data-object address associated with the data identifier from the private index using the private credential; and
recover the data object from the shared vault using the shared-vault-data-object address.
